(19) United States
(12) Patent Application Publication
(10) Pub. No.: US 2022/0026231 A1
(43) Pub. Date: Jan. 27, 2022

(54) DISPLAY METHODS AND SYSTEMS FOR INDICATOR ARROW IN NAVIGATION MAP

(71) Applicant: BEIJING DIDI INFINITY TECHNOLOGY AND DEVELOPMENT CO., LTD., Beijing (CN)

(72) Inventors: Haoran LI, Beijing (CN); Chong DENG, Beijing (CN)

(73) Assignee: BEIJING DIDI INFINITY TECHNOLOGY AND DEVELOPMENT CO., LTD., Beijing (CN)

(21) Appl. No.: 17/450,463

(22) Filed: Oct. 10, 2021

Related U.S. Application Data
(63) Continuation of application No. PCT/CN2020/084105, filed on Apr. 10, 2020.

(30) Foreign Application Priority Data
Apr. 10, 2019 (CN) 201910284301.4

(51) Int. Cl. G01C 21/36

(52) U.S. Cl. CPC G01C 21/3632; G01C 21/367

(57) ABSTRACT

The embodiment of the present disclosure discloses a display method and system for an indicator arrow in a navigation map. The method comprises: acquiring at least one indicator arrow information in a navigation route, the at least one indicator arrow information including at least one set of points representing the indicator arrow; determining a highest point of the indicator arrow on a screen based on the at least one indicator arrow information; determining a display position of the indicator arrow on the screen after placing the highest point at a preset position of the screen; and displaying the indicator arrow on the screen.

### CROSS-REFERENCE TO RELATED APPLICATIONS

This application is a continuation of International Application No. PCT/CN 2020/084105, filed on Apr. 10, 2020, which claims priority to China Patent Application No. 201910284301.4, filed on Apr. 10, 2019, the contents of which are incorporated herein by reference.

### FIELD OF THE INVENTION

The present disclosure relates to the technical field of navigation, and particularly relates to display methods and systems for an indicator arrow in a navigation map.

### BACKGROUND

In a navigation process, when a vehicle approaches a certain intersection, a user may be reminded in a form of an indicator arrow displayed in a navigation map. Since the navigation map will rotate with a moving direction of the user, a direction of the indicator arrow may change with the rotation of the navigation map. However, on an actual road, the variable shape of intersections (e.g., a sickle-shaped intersection, a 90-degree right-angle turning intersection, etc.) may cause that, when the navigation map rotates, the indicator arrow (or part of the indicator arrow) does not exist in the navigation map or the indicator arrow (or part of the indicator arrow) is located at a lower position of a screen displaying the navigation map. It is not convenient to view the navigation map for the user.

Thus, it is desirable to provide display methods and systems for an indicator arrow in a navigation map.

### SUMMARY

One embodiment of the present disclosure provides a display method for an indicator arrow in a navigation map. The method includes: acquiring at least one indicator arrow information in a navigation route, the at least one indicator arrow information including at least one set of points representing the indicator arrow; determining a highest point of the indicator arrow on a screen based on the at least one indicator arrow information; determining a display position of the indicator arrow on the screen after placing the highest point at a preset position of the screen; and displaying the indicator arrow on the screen.

One embodiment of the present disclosure provides a display system for an indicator arrow in a navigation map. The system includes at least one storage medium for storing a set of computer instructions; and at least one processor in communication with the at least one storage medium. When executing the set of computer instructions, the at least one processor is directed the system to perform operations including: acquiring at least one indicator arrow information in a navigation route, the at least one indicator arrow information including at least one set of points representing the indicator arrow; determining a highest point of the indicator arrow on a screen based on the at least one indicator arrow information; determining a display position of the indicator arrow on the screen after placing the highest point at a preset position of the screen; and displaying the indicator arrow on the screen.

One embodiment of the present disclosure provides a display system for an indicator arrow in a navigation map. The system includes: an acquiring module configured to acquire at least one indicator arrow information in a navigation route, the at least one indicator arrow information including at least one set of points representing the indicator arrow; a first determining module configured to determine a highest point of the indicator arrow on a screen based on the at least one indicator arrow information; a second determining module configured to determine a display position of the indicator arrow on the screen after placing the highest point at a preset position of the screen; and a display module configured to display the indicator arrow on the screen.

One embodiment of the present disclosure provides a display method for a turning arrow. The method includes: acquiring a turning arrow of at least one intersection, the turning arrow including at least one set of topological points; determining a highest topological point of the turning arrow; determining a display position of the turning arrow on the screen after placing the highest topological point of the turning arrow at a preset position on a screen; and displaying the turning arrow on the screen.

In some embodiments, the acquiring the turning arrow of the at least one intersection includes acquiring turning information of at least one intersection; and generating the turning arrow of at least one intersection according to the turning information of the at least one intersection.

In some embodiments, the determining the highest topological point of the turning arrow includes: establishing a rectangular coordinate system based on the screen, wherein a horizontal axis of the rectangular coordinate system is a horizontal direction of the screen, and a vertical axis of the rectangular coordinate system is a vertical direction of the screen; determining ordinate values of one set of topological points according to the rectangular coordinate system; and determining, from the set of topological points, a topological point with a greatest ordinate value as the highest topological point.

In some embodiments, the determining the display position of the turning arrow on the screen after placing the highest topological point of the turning arrow at the preset position on the screen includes: placing the highest topological point of the turning arrow at the preset position on the screen by zooming a map based on a display position of a vehicle identification on the screen, and determining the display position of the turning arrow on the screen.

In some embodiments, the displaying the turning arrow on the screen further includes: determining a proportional scale of the map when the highest topological point of the turning arrow is placed at the preset position of the screen; and determining whether the proportional scale is within a preset range; in response to determining that the proportional scale is within the preset range, displaying the turning arrow on the screen; and in response to determining that the proportional scale is not within the preset range, without displaying the turning arrow on the screen.

In some embodiments, the preset position is a straight line or a region.

In some embodiments, the preset position is a straight line, and a distance between the straight line and a position right above the screen is within a first pixel threshold.

In some embodiments, the turning arrow of at least one intersection is a turning arrow of a next intersection on the navigation route.

In some embodiments, the turning arrow is a 3D turning arrow.

In some embodiments, the turning arrow includes at least one of: a left turn arrow, a right turn arrow, a go-straight arrow, a turn-round turning arrow, etc.

One embodiment of the present disclosure provides a display system for a turning arrow. The system includes: a turning arrow acquiring module configured to acquire a turning arrow of at least one intersection, the turning arrow including at least one set of topological points; a highest topological point determining module configured to determine a highest topological point of the turning arrow; a display position determining module configured to determine a display position of the turning arrow on the screen after placing the highest topological point of the turning arrow at a preset position on a screen and a turning arrow display module configured to display the turning arrow on the screen.

In some embodiments, the turning arrow acquiring module further includes a turning information acquiring unit configured to acquire turning information of at least one intersection; and a turning arrow generating unit configured to generate the turning arrow of at least one intersection according to the turning information of at least one intersection.

In some embodiments, the highest topological point determining module further includes a coordinate system establishing unit configured to establish a rectangular coordinate system based on the screen, wherein a horizontal axis of the rectangular coordinate system is a horizontal direction of the screen, and a vertical axis of the rectangular coordinate system is a vertical direction of the screen; a coordinate value calculating unit configured to determine coordinate values of a set of topological points according to the rectangular coordinate system; and a highest topological point determining unit configured to determine a topological point with a greatest ordinate in the set of topological points as the highest topological point.

In some embodiments, the display position determining module is further configured to place the highest topological point of the turning arrow at the preset position on the screen by zooming a map based on a display position of a vehicle identification on the screen, and determine the display position of the turning arrow on the screen.

In some embodiments, the turning arrow display module further includes: a proportional scale determining unit configured to determine a proportional scale of the map when the calculated highest topological point of the turning arrow is placed at the preset position on the screen; and a turning arrow display unit configured to determine whether the proportional scale is within a preset range; in response to determining that the proportional scale is within the preset range, displaying the turning arrow on the screen; and in response to determining that the proportional scale is not within the preset range, without displaying the turning arrow on the screen.

One embodiment of the present disclosure provides a display device for a turning arrow. The device includes at least one processor and at least one storage medium; the at least one storage medium is configured to store computer instructions; and the at least one processor is configured to execute at least part of the computer instructions to perform operations according to any one of the embodiments of the present disclosure.

One embodiment of the present disclosure provides a computer-readable storage medium, the storage medium stores computer instructions, and when executing the computer instructions, a processor is directed to perform operations according to any one of the embodiments of the present disclosure.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram of an on-demand service system according to some embodiments of the present disclosure;

FIG. 2 is a block diagram of an exemplary computing device of a dedicated system for implementing technical solutions of the present disclosure;

FIG. 3 is a block diagram of an exemplary mobile device of a dedicated system for implementing technical solutions of the present disclosure;

FIG. 4 is a block diagram of an exemplary display system for an indicator arrow according to some embodiments of the present disclosure;

FIG. 5 is an exemplary flowchart of an exemplary display method for an indicator arrow according to some embodiments of the present disclosure;

FIG. 6 illustrates a plurality of exemplary indicator arrows according to some embodiments of the present disclosure;

FIG. 7 illustrates an exemplary rectangular coordinate system according to some embodiments of the present disclosure;

FIG. 8 illustrates an exemplary navigation interface for displaying an indicator arrow on a screen according to some embodiments of the present disclosure;

FIG. 9 illustrates an exemplary 3D indicator arrow according to an embodiment of the present disclosure; and

FIG. 10 illustrates a top view of an exemplary 3D indicator arrow on a two-dimensional screen according to an embodiment of the present disclosure.

### DETAILED DESCRIPTION

In order to more clearly describe the technical solutions of the embodiments of the present disclosure, the drawings that need to be used in the description of the embodiments will be briefly introduced below. Obviously, the drawings described below are only some examples or embodiments of the present disclosure. For those of ordinary skill in the art, without creative work, the present disclosure can be applied to other similar scenarios according to these drawings. Unless it is obvious from the language environment or otherwise stated, the same reference sign in the figures represents the same structure or operation.

It will be understood that the term “system,” “engine,” “unit,” “module,” and/or “block” used herein are one method to distinguish different components, elements, parts, sections, or assembly of different levels in ascending order. However, the terms may be displaced by another expression if they achieve the same purpose.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

The flowcharts used in the present disclosure illustrate operations that systems implement according to some embodiments in the present disclosure. It is to be expressly understood, the operations of the flowchart may be implemented not in order. Conversely, the operations may be implemented in an inverted order, or simultaneously. Moreover, one or more other operations may be added to the flowcharts. One or more operations may be removed from the flowcharts.

The embodiments of the present disclosure can be applied to different transportation systems, such as taxis, special cars, ride-sharing cars, buses, and substitute driving. The terms “service requester”, “service requester terminal”, “passenger”, “passenger terminal”, “customer”, “demander”, “service demander”, “service requester”, “consuming party”, “use demander”, etc., are used interchangeable and refer to a party that needs or orders a service, which can be an individual or a tool. Similarly, the terms “service provider”, “service provider terminal”, “driver”, “driver terminal”, “provider”, “supplier”, “service provider”, “servicer”, “service party”, etc., described in the present disclosure can also be used interchangeable, and refer to individuals, tools, or other entities or the like that provide services or assist in providing services. In addition, the term “user” described in the present disclosure may be a party that needs or orders the services, or a party that provides services or assists in providing services.

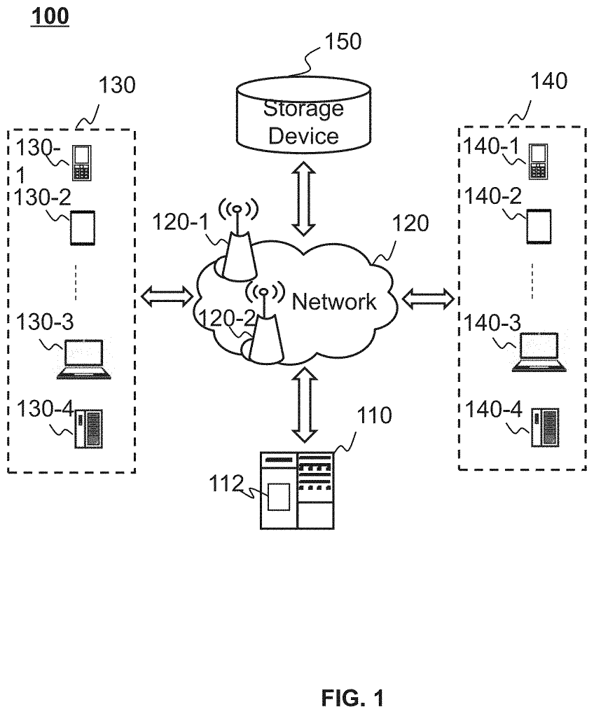

FIG. 1 is a schematic diagram of an on-demand service system 100 according to some embodiments of the present disclosure.

The on-demand service system 100 may be a service platform for the Internet or other networks. For example, the on-demand service system 100 may be used for an online service platform that provides transportation services. In some embodiments, the on-demand service system 100 may be applied to online car-hailing services, such as taxi calling, express calling, special car calling, minibus calling, carpooling, bus services, driver hiring, and pick-up and delivery services. In some embodiments, the on-demand service system 100 may also be applied to substitute driving, express delivery, take-away, etc. In some embodiments, the on-demand service system 100 may also be applied to the field of go-out (such as travel) services. The on-demand service system 100 may include a server 110, a network 120, a service requester terminal 130, a service provider terminal 140, and a storage device 150.

In some embodiments, the server 110 may be configured to process information and/or data related to service requests, for example, to process service requests for online taxi hailing. For another example, the server 110 may allocate a service request to the service provider terminal 140. For still another example, the server 110 may provide a navigation service for the service requester terminal 130 and/or the service provider terminal 140. In some embodiments, the server 110 may be a single server or a group of servers. The group of servers may be centralized or distributed (e.g., the server 110 may be a distributed system). In some embodiments, the server 110 may be local or remote. For example, the server 110 may access information and/or data stored in the service requester terminal 130 and the storage device 150 through the network 120. For still another example, the server 110 may be directly connected to the service requester terminal 130 and the storage device 150 to access the stored information and/or data. In some embodiments, the server 110 may be implemented on a cloud platform. For example, the cloud platform may include a private cloud, a public cloud, a hybrid cloud, a community cloud, a distributed cloud, an inter-cloud, a multiple clouds, or the like, or any combination thereof.

The network 120 may facilitate exchange of information and/or data. In some embodiments, one or more components of the on-demand service system 100 (e.g., the server 110, the service requester terminal 130, the service provider terminal 140, and the storage device 150) may send/receive information and/or data to/from the on-demand service system 100 via the network 120. For example, the server 110 may receive the service request from the service requester terminal 130 or allocate the service request to the service provider terminal 140 through the network 120. In some embodiments, the network 120 may be a wired or wireless network of any form or any combination thereof. For example, the network 120 may include a cable network, a wired network, an optical network, a telecommunication network, an internal network, the Internet, a Local Area Network (LAN), a Wide Area Network (WAN), a Wireless Local Area Network (WLAN), a Metropolitan Area Network (MAN), a Wide Area Network (WAN), a Public Switched Telephone Network (PSTN), a Bluetooth network, a Zigbee network, a Near Field Communication (NFC) network, a Global System for Mobile Communications (GSM) network, a Code Division Multiple Access (CDMA) network, a Time Division Multiple Access (TDMA) network, a General Packet Radio Service (GPRS) network, an enhanced data rate GSM evolution (EDGE) network, a Wideband Code Division Multiple Access (WCDMA) network, a High Speed Downlink Packet Access (HSDPA) network, a Long Term Evolution (LTE) network, a User Datagram Protocol (UDP) network, a Transmission Control Protocol/Internet Protocol (TCP/IP) network, a Short Message Service (SMS) network, a Wireless Application Protocol (WAP) network, an Ultra Wide Band (UWB) network, infrared, or the like, or any combination thereof. In some embodiments, the on-demand service system 100 may include one or more network access points. For example, the on-demand service system 100 may include wired or wireless network access points, such as base stations and/or wireless access points 120-1, 120-2, . . . , through which one or more components of the on-demand service system 100 may be connected to the network 120 to exchange data and/or information.

In some embodiments, the service requester terminal 130 and/or the service provider terminal 140 may be individuals, tools, or other entities that issue service orders. In some embodiments, the service requester terminal 130 and/or the service provider terminal 140 may be used in a system that analyzes and processes collected information to generate an analysis result. For example, the service requester terminal 130 and/or the service provider terminal 140 may acquire at least one indicator arrow information in a navigation route, wherein the indicator arrow information may include at least one set of points that represent an indicator arrow. The service requester terminal 130 and/or the service provider terminal 140 may determine a highest point of the indicator arrow on a screen based on at least one indicator arrow information. The service requester terminal 130 and/or the service provider terminal 140 may place the highest point at a preset position of the screen, and determines a display position of the indicator arrow on the screen. The service requester terminal 130 and/or the service provider terminal 140 may display the indicator arrow on the screen.

In some embodiments, the service requester terminal 130 may include a mobile device 130-1, a tablet personal computer 130-2, a notebook computer 130-3, a vehicle-mounted device 130-4 in a motor vehicle, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a smart electrical appliance control device, a smart monitoring device, a smart TV, a smart camera, an intercome, or the like, or any combination thereof. In some embodiments, the wearable device may include a smart bracelet, smart footwear, smart glasses, a smart helmet, a smart watch, smart wearing, a smart backpack, smart accessories, or the like, or any combination thereof. In some embodiments, the smart mobile device may include a smart phone, a personal digital assistant (PDA), a gaming device, a navigation device, a point of sales (POS), or the like, or any combination thereof. In some embodiments, the virtual reality device and/or the augmented reality device may include a virtual reality helmet, virtual reality glasses, virtual reality goggles, an augmented virtual reality helmet, augmented reality glasses, augmented reality goggles, or the like, or any combination thereof. For example, the virtual reality device and/or the augmented reality device may include Google Glass, Oculus Rift, HoloLens, or Gear VR, or the like. In some embodiments, the in-vehicle device 130-4 in the motor vehicle may include an in-vehicle computer, an in-vehicle TV, etc. In some embodiments, the service requester terminal 130 may be a device with a positioning technology and is used for positioning a position of a service requester and/or the service requester terminal 130.

In some embodiments, the service provider terminal 140 may be a device similar to or the same as the service requester terminal 130. In some embodiments, the service requester terminal 130/service provider terminal 140 may be a device with a positioning function. In some embodiments, the service requester terminal 130 and/or the service provider terminal 140 may communicate with another positioning device to determine positions of the service requester, the service requester terminal 130, a service provider, and/or the service provider terminal 140. In some embodiments, the service provider terminal 140 may include a mobile device 140-1, a tablet personal computer 140-2, a notebook computer 140-3, a vehicle-mounted device 140-4 in a motor vehicle, or the like, or any combination thereof. In some embodiments, the service requester terminal 130 and/or the service provider terminal 140 may send positioning information to the server 110.

The storage device 150 may store data and/or instructions related to the service request. In some embodiments, the storage device 150 may store data obtained/acquired from the service requester terminal 130 and/or the service provider terminal 140. In some embodiments, the storage device 150 may store data and/or instructions executed or used by the server 110 to complete exemplary methods described in the present disclosure. In some embodiments, the storage device 150 may include a mass memory, a removable memory, a volatile read-write memory, a read-only memory (ROM), or the like, or any combination thereof. An exemplary mass memory may include a magnetic disk, an optical disk, a solid state disk, etc. An exemplary removable memory may include a flash drive, a floppy disk, an optical disk, a storage card, a compact disk, a magnetic tape, etc. An exemplary volatile read-only memory may include a random access memory (RAM). An exemplary RAM may include a dynamic RAM (DRAM), a double data rate synchronous dynamic RAM (DDR SDRAM), a static RAM (SRAM), a thyristor RAM (T-RAM), a zero capacitance RAM (Z-RAM), etc. An exemplary ROM may include a mask ROM (MROM), a programmable ROM (PROM), an erasable-programmable ROM (EPROM), an electronically erasable-programmable ROM (EEPROM), a compact disk ROM (CD-ROM), a digital general-purpose disk ROM, etc. In some embodiments, the storage device 150 may be implemented on a cloud platform. As an example only, the cloud platform may include private cloud, public cloud, hybrid cloud, community cloud, distributed cloud, internal cloud, multi-layer cloud, or the like, or any combination thereof.

In some embodiments, the storage device 150 may be connected to the network 120 to communicate with one or more components in the on-demand service system 100 (e.g., the server 110, the service requester terminal 130, and the service provider terminal 140). One or more components in the on-demand service system 100 may access the data or instructions stored in the storage device 150 through the network 120. In some embodiments, the storage device 150 may directly connect or communicate with one or more components in the on-demand service system 100 (e.g., the server 110, the service requester terminal 130, the service provider terminal 140, etc.). In some embodiments, the storage device 150 may be part of the server 110.

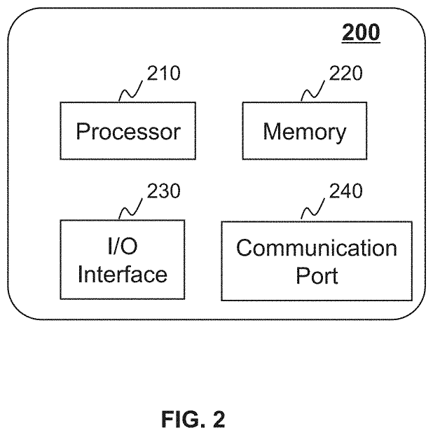

FIG. 2 is a block diagram of an exemplary computing device 200 of a dedicated system for implementing technical solutions of the present disclosure.

As shown in FIG. 2, the computing device 200 may include a processor 210, a memory 220, an input/output interface 230, and a communication port 240.

The processor 210 may execute calculation instructions (program codes) and execute functions of the on-demand service system 100 described in the present disclosure. The calculation instructions may include programs, objects, components, data structures, processes, modules, and functions (the functions refer to specific functions described in the present disclosure). For example, the processor 210 may process images or text data obtained from any other components of the on-demand service system 100. In some embodiments, the processor 210 may include a microcontroller, a microprocessor, a reduced instruction set computer (RISC), an application specific integrated circuit (ASIC), an application specific instruction set processor (ASIP), a central processing unit (CPU), a graphics processing unit (GPU), a physical processing unit (PPU), a microcontroller unit, a digital signal processor (DSP), a field programmable gate array (FPGA), an advanced RISC machine (ARM), a programmable logic device and any circuit, processor, etc. that may perform one or more functions, or any combination thereof. For illustration only, the computing device 200 in FIG. 2 only describes one processor, but it should be noted that the computing device 200 in the present disclosure may also include a plurality of processors.

The memory 220 may store data/information obtained from any other components of the on-demand service system 100. In some embodiments, the memory 220 may include a mass memory, a removable memory, a volatile read-write memory, a read-only memory (ROM), or the like, or any combination thereof. An exemplary mass memory may include a magnetic disk, an optical disk, a solid state drive, etc. The removable memory may include a flash drive, a floppy disk, an optical disk, a storage card, a compact disk, a magnetic tape, etc. The volatile read-write memory may include a random access memory (RAM). The RAM may include a dynamic RAM (DRAM), a double data rate synchronous dynamic RAM (DDR SDRAM), a static RAM (SRAM), a thyristor RAM (T-RAM), a zero capacitance RAM (Z-RAM), etc. The ROM may include a mask ROM (MROM), a programmable ROM (PROM), an erasable-programmable ROM (EPROM), an electronically erasable-programmable ROM (EEPROM), a compact disk ROM (CD-ROM), a digital general-purpose disk ROM, etc.

The input/output (I/O) interface 230 may be configured to input or output signals, data, or information. In some embodiments, the input/output interface 230 may enable a user to communicate with the on-demand service system 100. In some embodiments, the input/output interface 230 may include an input device and an output device. An exemplary input device may include a keyboard, a mouse, a touch screen, a microphone, or the like, or any combination thereof. An exemplary output device may include a display device, a loudspeaker, a printer, a projector, or the like, or any combination thereof. An exemplary display device may include a liquid crystal display (LCD), a light-emitting diode (LED)-based display, a flat-panel display, a curved display, television equipment, a cathode ray tube (CRT), or the like, or any combination thereof. The communication port 240 may be connected to a network for data communication. The connection may be wired connection, wireless connection, or a combination of both. The wired connection may include a cable, an optical cable or a telephone line, or the like, or any combination thereof. The wireless connection may include Bluetooth, Wi-Fi, WiMax, WLAN, ZigBee, a mobile network (e.g., 3G, 4G, or 5G, etc.), or the like, or any combination thereof. In some embodiments, the communication port 240 may be a standardized port, such as RS232 and RS485. In some embodiments, the communication port 240 may be a specially designed port.

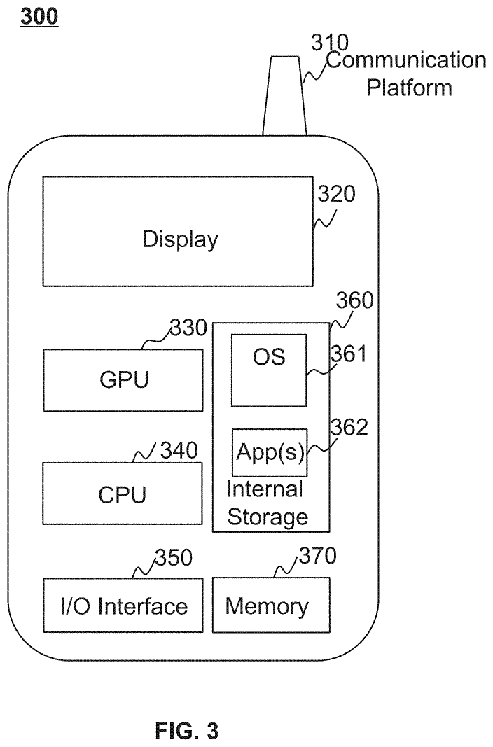

FIG. 3 is a block diagram of an exemplary mobile device 300 of the dedicated system for implementing technical solutions of the present disclosure.

As shown in FIG. 3, the mobile device 300 may include a communication platform 310, a display 320, a graphics processing unit (GPU) 330, a central processing unit (CPU) 340, an input/output interface 350, an internal storage 360, a memory 370, etc. In some embodiments, an operating system 361 (e.g., iOS, Android, Windows Phone, etc.) and an application program 362 may be loaded from the memory 370 into the internal storage 360 so as to be executed by the CPU 340. The application program 362 may include a browser or an application program for receiving imaging, graphics processing, audio, or other related information from the on-demand service system 100.

In order to realize various modules, units and functions thereof described in the present disclosure, the computing device or the mobile device may be used as a hardware platform for one or more components described in the present disclosure. These hardware components, operating systems, and programming languages of the computer or the mobile device are conventional in nature, and those skilled in the art may adapt these technologies to the on-demand service system described in the present disclosure after being familiar with these technologies. A computer with user interface elements may be configured to implement a personal computer (PC) or other types of workstations or terminal devices. If properly programmed, the computer may also act as a server.

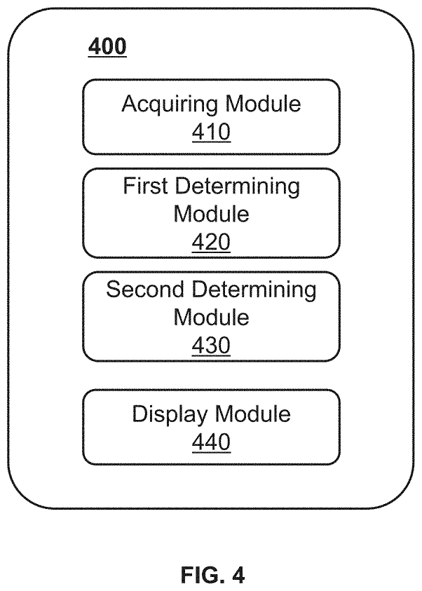

FIG. 4 is a block diagram of an exemplary display system 400 for an indicator arrow according to some embodiments of the present disclosure. The system 400 may acquire at least one indicator arrow information in a navigation route, and determine a highest point of the indicator arrow on a screen, then place the highest point at a preset position of the screen to determine a display position of the indicator arrow on the screen, and display the indicator arrow on the screen.

As shown in FIG. 4, the system 400 may include an acquiring module 410, a first determining module 420, a second determining module 430, and a display module 440.

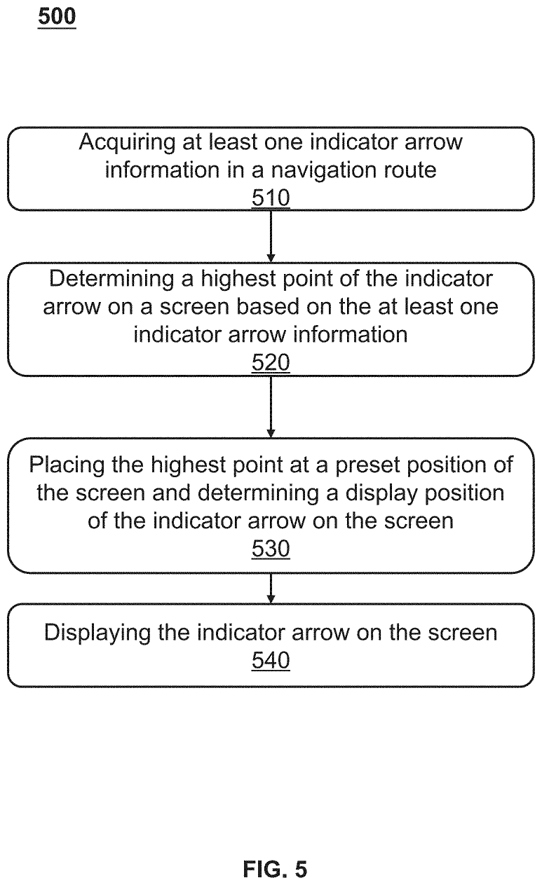

The acquiring module 410 may be configured to obtain at least one indicator arrow information on a navigation route. The indicator arrow information may include at least one set of points representing the indicator arrow. For example, the acquiring module 410 may acquire at least one road transformation information, and then generates an indicator arrow corresponding to the at least one road transformation information based on the at least one road transformation information. More descriptions about acquiring the at least one indicator arrow information on the navigation route may be found in FIG. 5 and its descriptions.

The first determining module 420 may be configured to determine the highest point of the indicator arrow on the screen based on the at least one indicator arrow information. For example, the first determining module 420 may establish a rectangular coordinate system on the screen, and determine coordinate values of a set of pixel points in the indicator arrow based on the rectangular coordinate system. The first determining module 420 may determine, in the set of pixel points, a pixel point with a largest ordinate value as the highest point of the indicator arrow. More description about determining the highest point of the indicator arrow on the screen may be found in FIG. 5 and its descriptions.

The second determining module 430 may be configured to place the highest point at a preset position of the screen, and determine the display position of the indicator arrow on the screen. For example, the second determining module 430 may obtain a display position of a vehicle identification on the screen, and place the highest point of the indicator arrow at the preset position on the screen by zooming a navigation map based on the display position of the vehicle identification on the screen. The second determining module 430 may determine the display position of the indicator arrow on the screen. More descriptions about determining the display position of the indicator arrow on the screen may be found in FIG. 5 and its descriptions.

The display module 440 may be configured to display the indicator arrow on the screen. For example, the display module 440 may determine a proportional scale of the navigation map when the highest point is placed at the preset position of the screen, and determine whether the proportional scale is within a preset range. If the proportional scale is within a preset range, the display module 440 may display the indicator arrow on the screen; and if the proportional scale is not within the preset range, the display module 440 may not display the indicator arrow on the screen. In some embodiments, the display module 440 may also acquire a road width of a road where the indicator arrow is located, and determine a width of the indicator arrow based on the road width and the proportional scale. The display module 440 may display the indicator arrow on the screen according to the width. More descriptions about displaying the indicator arrow on the screen may be found in FIG. 5 and its descriptions.

It should be understood that the system and its modules shown in FIG. 4 may be implemented in various ways. For example, in some embodiments, the system and its modules may be implemented by hardware, software, or a combination of software and hardware, wherein, a hardware part may be implemented by using special logic; a software part may be stored in a memory and executed by an appropriate instruction executing system, such as a microprocessor or specially designed hardware. Those skilled in the art may understand that the above-mentioned method and system may be implemented by using computer-executable instructions and/or by being included in processor control codes, for example, on a carrier medium such as a magnetic disk, CD or DVD-ROM, a programmable memory such as a read-only memory (firmware) or a data carrier such as an optical or electronic signal carrier, such a code is provided. The system and its modules of the present disclosure not only may be implemented by hardware circuits such as super-large-scale integrated circuits or gate arrays, semiconductors such as logic chips, and transistors, or programmable hardware devices such as field programmable gate arrays, and programmable logic devices, but also may be implemented by software executed by various types of processors, or may also be implemented by a combination of the above hardware circuit and software (e.g., firmware).

It should be noted that the above description about the display system for the indicator arrow and its modules is only for convenience of descriptions, and does not limit the present disclosure within a scope of embodiments mentioned. It may be understood that for those skilled in the art, after understanding the principle of the system, it is possible to arbitrarily combine various modules, or form subsystems to connect with other modules without departing from this principle. For example, in some embodiments, the acquiring module 410, the first determining module 420, the second determining module 430, and the display module 440 disclosed in FIG. 4 may be different modules in one system and may also be one module to achieve the functions of two or more modules. For another example, the first determining module 420 and the second determining module 430 may be two modules, or may also be one module which simultaneously has functions of determining the highest point of the indicator arrow on the screen and determining the display position of the indicator arrow on the screen. For still another example, all the modules may share a storage module, and all the modules may also have respective storage module. Such deformations are all within the scope of protection of the present disclosure.

FIG. 5 is an exemplary flowchart of an exemplary display method 500 for an indicator arrow according to some embodiments of the present disclosure.

In some embodiments, the display method 500 for the indicator arrow may be executed by a device having processing and computing capabilities such as the service requester terminal 130, the service provider terminal 140, or the mobile device 300. Correspondingly, the display system 400 for the indicator arrow may be hardware, software, or a combination of software and hardware of the service requester terminal 130, the service provider terminal 140, or the mobile device 300.

In some embodiments, the displaying method 500 for the indicator arrow may also be executed by a device having processing and computing capabilities such as the server 110 or the computing device 200. Correspondingly, the display system 400 for the indicator arrow may be hardware, software, or a combination of software and hardware of the server 110 or the computing device 200.

As shown in FIG. 5, the display method 500 for the indicator arrow may include:

Step 510, acquiring at least one indicator arrow information in a navigation route. Specifically, step 510 may be executed by the acquiring module 410.

The navigation route may be a route on a user terminal (e.g., the service requester terminal 130 or/and the service provider terminal 140) that indicates where a vehicle of the user terminal is located. After acquiring a starting point and an ending point input by a user, the user terminal may enter a navigation state after receiving the navigation route from the server 110.

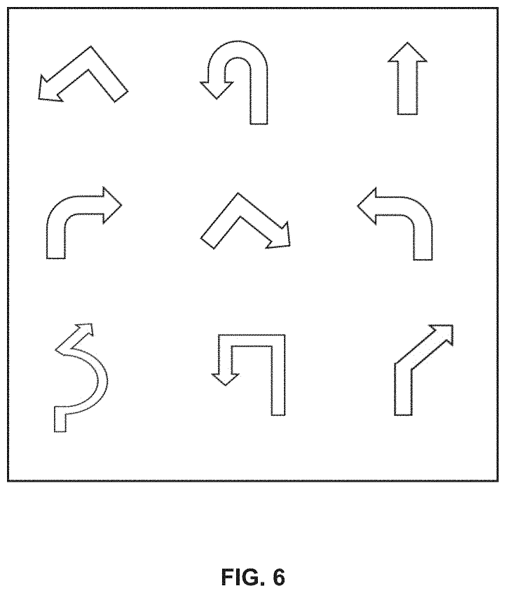

The navigation route may include a series of indicator arrows that guide the vehicle to transform a road. Road transformation may be that the vehicle travels from one road to another road, for example, turns at an intersection, lane changing between main and auxiliary roads, or turning around, etc. Due to different forms of road transformation on the navigation route, a series of different indicator arrows may be included. In some embodiments, as shown in FIG. 6, the indicator arrow may include at least one of the following: a left turn arrow, a right turn arrow, a go-straight arrow, a turn-round turning arrow, an annular driving arrow, a continuous turning arrow, a left front driving arrow, or a right front driving arrow. The left turn arrow may include a left right-angle turning arrow and a left oblique turning arrow. The right turn arrow may include a right right-angle turning arrow and a right diagonal turning arrow. The continuous turning arrow may include indicator arrows of two or more turning intersections that are closer to each other. The left front driving arrow may include an indicator arrow for driving from an auxiliary road to a main road. The right front driving arrow may include an indicator arrow for driving from the main road to the auxiliary road.

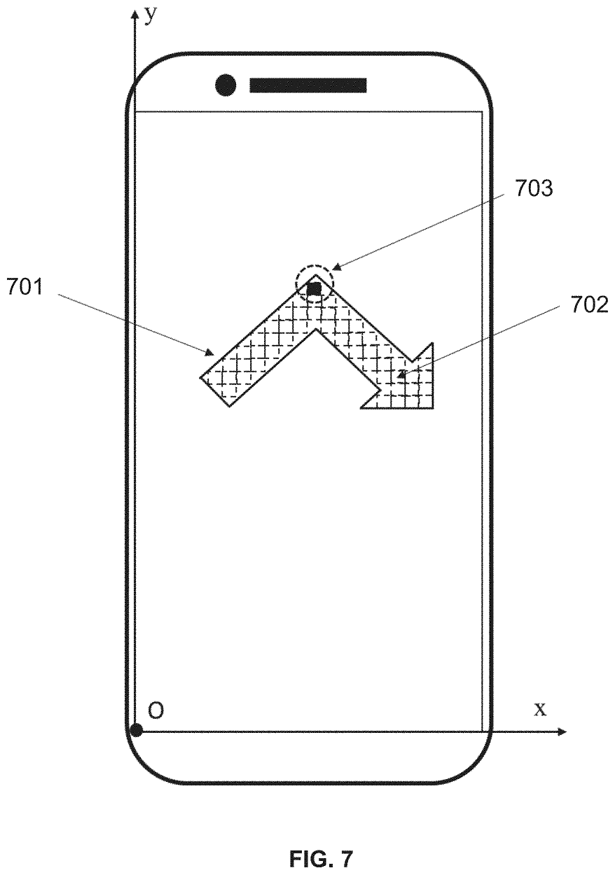

In some embodiments, the indicator arrow information may include coordinate data of a road transformation position corresponding to the indicator arrow. The coordinate data corresponds to a latitude and longitude of the road transformation position. The indicator arrow information may include at least one set of points (or referred to as topological points) representing the indicator arrow. As shown in FIG. 7, an indicator arrow 701 may include a set of points 702 (shown in a dotted block in FIG. 7). The set of points 702 form a shape and a direction of the indicator arrow. The user drives the vehicle by observing the direction of the indicator arrow.

In some embodiments, the indicator arrow may include a 3D indicator arrow, a 2.5D indicator arrow, or a 2D indicator arrow. If the 2D indicator arrow is used as a turning or lane changing indication sign, it may not be able to make an accurate prompt during complex road transformation, and a visual effect is poor, which may cause the user to drive in a wrong lane and cause a lot of inconvenience to the user. Since the 3D indicator arrow has a certain thickness compared to the 2D and 2.5D indicator arrows, and gives the user a more intuitive look and feel, when the indicator arrow is the 3D indicator arrow, the user may more intuitively observe changes in a road ahead.

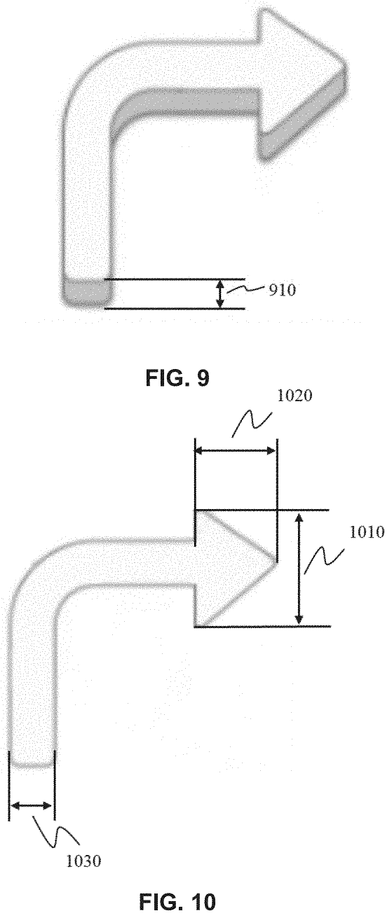

In some embodiments, as shown in FIG. 9, the indicator arrow is a 3D indicator arrow, and the 3D indicator arrow has a certain thickness. A mark 910 as shown in FIG. 9 indicates a thickness of the 3D indicator arrow. FIG. 10 is a schematic view of the 3D indicator arrow of FIG. 9 when be viewed down from a position right above the screen in a 2D viewing angle (or an orthographic projection view on the screen). As shown in FIG. 10, a mark 1010 indicates a width of a head arrow of the indicator arrow, a mark 1020 indicates a height of the head arrow of the indicator arrow, and a mark 1030 indicates a width of the indicator arrow. In the 2D viewing angle (that is, being viewed down the 3D arrow from the position right above the screen), the width of the head arrow (the mark 1010 as in FIG. 10) and the height of the head arrow (the mark 1020 as in FIG. 10) of the 3D indicator arrow, and the width of the 3D indicator arrow (the mark 1030 as in FIG. 10), and the thickness of the 3D indicator arrow (the mark 910 as in FIG. 9) may maintain a certain ratio. The ratio may be a ratio that is convenient for the user to observe and provides a good visual effect. For example, the ratio may be 58:44:32:8. Taking the ratio as a reference, when the user zooms the navigation map, the indicator arrow may achieve an equal-proportion adaptation under different proportional scales. In some embodiments, if the indicator arrow is a 2D indicator arrow, a width of a head arrow (the mark 1010 as in FIG. 10) and a height of the head arrow (the mark 1020 as in FIG. 10) of the 2D indicator arrow, and a width of the 2D indicator arrow (the mark 1030 as in FIG. 10) may also maintain a certain ratio. Taking the ratio as a reference, when the user zooms the navigation map, the indicator arrow may achieve an equal-proportion adaptation under different proportional scales. In some embodiments, in order not to cover the navigation route and to facilitate observation by the user, a certain pixel may be maintained from the indicator arrow to a base map (that is, a two-dimensional map displayed on the screen). For example, the indicator arrow may be 7 pixels away from the base map.

In some embodiments, the acquiring module 410 may acquire road transformation information to acquire at least one indicator arrow information in the navigation route. For example, at least one road transformation information may be acquired, and then an indicator arrow corresponding to the at least one road transformation information may be generated based on the at least one road transformation information. The road transformation information may include information such as a shape of an intersection, position information of the intersection, turning angle information of the intersection, whether to turn around, whether to go straight, whether to change lanes, etc. The indicator arrow may include an indicator arrow corresponding to next road transformation information on the navigation route. The acquiring module 410 may acquire at least one road transformation information, and draw at least one indicator arrow at a road transformation position according to shapes of at least two roads at the road transformation position.

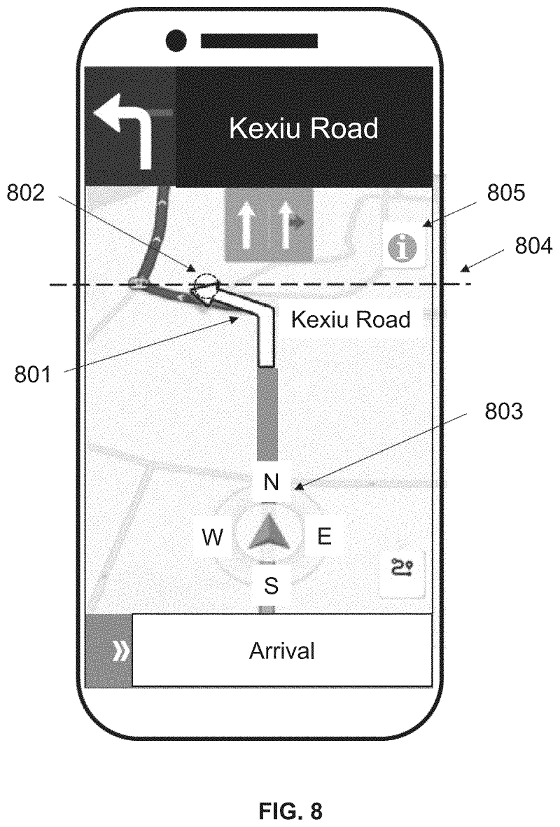

Taking a road in FIG. 8 as an example, a vehicle will drive to the left front of the road, and the acquiring module 410 may determine a turning angle of two roads based on a current road and a road that the vehicle will drive into. Further, based on the turning angle and position information of the two roads on the navigation map, the indicator arrow indicating the vehicle to drive to the left front (an indicator arrow 801 as in FIG. 8) is generated, and a shape of the indicator arrow is similar to a shape of a road turning to the left front.

Step 520: determining a highest point of the indicator arrow on a screen based on the at least one indicator arrow information. Specifically, step 520 may be executed by the first determining module 420.

The screen may include a terminal device that displays the navigation route, for example, a user terminal or a projection device connected to the user terminal. In some embodiments, the highest point of the indicator arrow may be a highest point in a vertical direction of the screen where the indicator arrow is located.

In some embodiments, the first determining module 420 may establish a rectangular coordinate system on the screen, and then determine a point with a greatest ordinate value of the indicator arrow as the highest point of the indicator arrow. For example, the rectangular coordinate system may be established on the screen, a horizontal axis of the rectangular coordinate system is a horizontal direction of the screen, and a vertical axis of the rectangular coordinate system is a vertical direction of the screen. Coordinate values of a set of points in the indicator arrow may be determined based on the rectangular coordinate system, and a point with a greatest ordinate value in the set of points may be determined as the highest point of the indicator arrow.

A mobile phone screen is taken as an example for description below. FIG. 7 illustrates an exemplary rectangular coordinate system according to some embodiments of the present disclosure. In some embodiments, coordinates of one set of points of the indicator arrow on the mobile phone screen are (X, Y), and a unit of the rectangular coordinate system is a pixel. For example, as shown in FIG. 7, the first determining module 420 may designate a lower left corner of the screen as an origin O, a horizontal axis (x axis) is a horizontal direction of the screen, and a vertical axis (y axis) is a vertical direction of the screen. The first determining module 420 may determine coordinate values of a set of points in the indicator arrow according to the rectangular coordinate system. The coordinate value indicates a position of a pixel point of the set of points on the screen. For example, if a resolution of the mobile phone screen is 1280×720, there are 1280 pixel points in the y-axis direction of the mobile phone screen, and there are 720 pixel points in the x-axis direction of the mobile phone screen. A coordinate value of the origin is (0, 0), and a coordinate value of an upper right corner of the mobile phone screen is (720, 1280). As shown in FIG. 7, the indicator arrow 701 is composed of the set of points 702 (shown in a dotted block in FIG. 7), and a point with a greatest ordinate in the set of points in the indicator arrow is a point 703 shown by a dotted circle in FIG. 7. The point 703 may be a highest point in the vertical direction (y-axis) of the mobile phone screen.

In some embodiments, the indicator arrow enters the screen. According to the above method, the first determining module 420 may determine the highest point of the indicator arrow in the vertical direction of the screen based on the at least one indicator arrow information.

Step 530, placing the highest point at a preset position of the screen and determining a display position of the indicator arrow on the screen. Specifically, step 530 may be executed by the second determining module 430.

The preset position may be a display position predetermined according to viewing habits of the user or the visual effect, and the preset position may be a comfortable position on the screen that facilitates observing by the user. In some embodiments, the preset position may be a straight line (e.g., a dotted line 804 below a button 805 in FIG. 8) or a region (e.g., a certain-area region near a vertical center line in FIG. 8) with a first pixel threshold from a position right above the screen. The position right above the screen may be a highest position in the vertical direction of the screen. Still taking the mobile phone screen in step 520 as an example, the position right above the screen may be a straight line with y=1280. In some embodiments, the first pixel threshold may be a default value of the system, for example, 100 pixel values, 150 pixel values, or 200 pixel values, or may also be adjusted according to different situations.

In some embodiments, the second determining module 430 may place the highest point at a preset position of the screen based on a display position of a vehicle identification on the screen (e.g., a vehicle identification 803 in FIG. 8) to determine the display position of the indicator arrow on the screen. For example, the display position of the vehicle identification on the screen may be acquired, and based on the display position of the vehicle identification on the screen, the highest point of the indicator arrow may be placed at the preset position on the screen by zooming the navigation map, and then the display position of the indicator arrow on the screen may be determined.

In some embodiments, the display position of the vehicle identification on the screen may remain unchanged. For example, the vehicle identification may be displayed at a center point of the screen, a certain point close to a position below a vertical centerline of the screen, or other position. In some embodiments, the second determining module 430 may first fix the display position of the vehicle identification on the screen, and then place the determined highest point of the indicator arrow at the preset position by zooming the navigation map. The second determining module 430 may determine the display position of the indicator arrow on the screen.

Taking the display position of the indicator arrow on the mobile phone screen as an example for description below, as shown in FIG. 8, the position of the vehicle identification (that is, the current position of the vehicle) on the screen may remain unchanged (e.g., at a certain point 803 below the vertical centerline of the mobile phone screen), when the navigation map is zoomed, a scope of a navigation map will be zoomed in or out with the vehicle identification as a center. While zooming, a position of the highest point of the indicator arrow may also move accordingly. For example, when the navigation map is zoomed in, the highest point of the indicator arrow will be far away from the vehicle identification (e.g., the indicator arrow may be out of the screen display), and when the navigation map is zoomed out, the highest point of the indicator arrow will be close to the vehicle identification (e.g., entering the screen display from a position outside the screen display). Therefore, by trying to zoom the navigation map to an appropriate proportional scale, the highest point of the indicator arrow (e.g., a point 802 in the indicator arrow in FIG. 8) is exactly at the preset position (e.g., aligned with the dotted line 804 in FIG. 8) on the screen. When the navigation map rotates, the highest point of the indicator arrow will also change, the changed highest point is still placed at the preset position (e.g., aligned with the dotted line 804), thereby avoiding the indicator arrow is out of the navigation interface or is located too close to a lower portion of the screen, and improving the visual effect.

In some embodiments, the position of the vehicle identification on the screen may be changed. For example, when the determined highest point of the indicator arrow (e.g., the point 802 in the indicator arrow in FIG. 8) is aligned with the preset position (e.g., the dotted line 804 in FIG. 8) by zooming the navigation map, and when the position of the vehicle identification on the screen changes, a position for placing the highest point may also change accordingly, but the highest point is still aligned with the preset position (e.g., the dotted line 804 in FIG. 8). For example, when the vehicle identification moves leftwards, the position for placing the highest point also moves leftwards, and therefore the position of the indicator arrow also shifts leftwards. It may be understood that when the position of the vehicle identification on the screen changes, the position for placing the highest point in the indicator arrow in FIG. 8 may also change accordingly, but the position of the highest point only moves left and right on the dotted line 804 in FIG. 8.

Step 540, displaying the indicator arrow on the screen. Specifically, step 540 may be executed by the display module 440.

In some embodiments, the display module 440 may display the indicator arrow on the screen. For example, a proportional scale of the navigation map may be determined when the highest point is placed at the preset position of the screen, and whether the proportional scale is within a preset range may be determined. If the proportional scale is within a preset range, the indicator arrow may be displayed on the screen; and if the proportional scale is not within a preset range, the indicator arrow may be not displayed on the screen. In some embodiments, the preset range may include levels 15-19, and the preset range may also be adjusted according to different situations.

Placing the determined highest point of the indicator arrow at the preset position on the screen is achieved by zooming the navigation map. Therefore, when the navigation map is zoomed, the proportional scale of the navigation map may also be changed accordingly. When the navigation map is zoomed so that the highest point of the indicator arrow is exactly located at the preset position on the screen, the display module 440 may record the proportional scale of the navigation map at this time.

For illustrative descriptions only, when the display module 440 determines that the proportional scale (e.g., the level 16) of the navigation map at this time is greater than the level 15, the display module 440 may display the indicator arrow on the screen. Conversely, when the display module 440 determines that the proportional scale (e.g., a level 14) of the navigation map at this time is less than the level 15, the display module 440 does not display the indicator arrow on the screen, that is, the user cannot observe the indicator arrow on the screen. As the vehicle moves forward, the proportional scale of the navigation map changes, and the display module 440 will not display the indicator arrow on the screen until the proportional scale of the navigation map reaches the level 15.

In some embodiments, the indicator arrow is displayed when the proportional scale is greater than or equal to the level 15. When the proportional scale changes dynamically during the navigation process, it may be determined at any time whether the proportional scale meets a requirement for displaying the indicator arrow. In some embodiments, when an original proportional scale (e.g., the level 17) on a navigation interface is greater than or equal to the level 15, the indicator arrow is displayed on the screen. If the proportional scale is zoomed out to be below the level 15 (e.g., to a level 13) artificially by the user (e.g., by a zooming gesture or by clicking zoom control), the indicator arrow will no longer be displayed. In some embodiments, the original proportional scale on the navigation interface is less than the level 15 (e.g., the level 13), and the indicator arrow is not displayed on the screen. If the proportional scale is zoomed in to be greater than or equal to the level 15 (e.g., the level 17) artificially by the user (e.g., by the zooming gesture or by clicking the zoom control), the indicator arrow will be displayed. In some embodiments, the navigation interface may include a full-screen navigation interface or a non-full-screen navigation interface.

In some embodiments, the display module 440 may determine a width of the indicator arrow and perform display according to the width. For example, a road width of a road where the indicator arrow is located may be acquired, and then based on the road width and the proportional scale on the navigation interface, the width of the indicator arrow (the mark 1030 as in FIG. 10) is determined, and the indicator arrow is displayed on the screen according to the width.

In some embodiments, the width of the indicator arrow may be calculated by formulas (1) and (2):

$$\begin{matrix}{W}_{A r r o w} = {W}_{L i n e} \times w & ( 1 ) \\ w = cos ( \vert 20.0 f - lev \vert \times 10 \times \frac{π}{180} ) \times k & ( 2 )\end{matrix}$$

Wherein, W_{ARROW} denotes the width of the indicator arrow, W_{Line} denotes the road width of the road corresponding to the indicator arrow, lev denotes the proportional scale on the current navigation interface, 20.0f denotes a maximum level of the proportional scale, and k denotes a micro adjustment parameter (e.g., k=0.8).

In some embodiments, if the indicator arrow is a 3D indicator arrow, the display module 440 may determine a size of the 3D indicator arrow based on the width of the indicator arrow, and the indicator arrow may be displayed on the screen according to the ratio of the width of the head arrow, the height of the head arrow of the indicator arrow, the width of the indicator arrow, and the thickness of the indicator arrow described in step 510.

In some embodiments, if the indicator arrow is a 2D indicator arrow, the display module 440 may determine a size of the 2D indicator arrow based on the width of the indicator arrow, and the indicator arrow may be displayed on the screen according to the ratio of the width of the head arrow, the height of the head arrow of the indicator arrow, and the width of the indicator arrow described in step 510.

It should be noted that the foregoing description about a process 500 is only for an example and description, and does not limit the scope of application of the present disclosure. For those skilled in the art, various modifications and changes may be made to the process 500 under the guidance of the present disclosure. However, these modifications and changes are still within the scope of the present disclosure. For example, a sum preset range of the first pixel threshold is not limited to values listed in the process 500, and may also be other values.

The possible beneficial effects of the embodiments of the present disclosure include, but are not limited to: by placing the highest point of the indicator arrow of the next road transformation position during the driving process of the vehicle at the preset position of the screen (e.g., the best display position), the indicator arrow may always be at the preset position of the screen along with the change of the navigation map, which is convenient for the user to watch the indicator arrow, and therefore may better guide the user to drive the vehicle, and a navigation experience of the user is improved. It should be explained that different embodiments may have different beneficial effects. In different embodiments, the possible beneficial effects may be any one or a combination of the above, or any other beneficial effects that may be obtained.

The basic concepts have been described above. Obviously, for those skilled in the art, the above detailed disclosure is only an example, and does not constitute a limitation to the present disclosure. Although it is not explicitly stated here, those skilled in the art may make various modifications, improvements and corrections to the present disclosure. Such modifications, improvements, and corrections are suggested in the present disclosure, so such modifications, improvements, and corrections still belong to the spirit and scope of the exemplary embodiments of the present disclosure.

At the same time, the present disclosure uses specific words to describe the embodiments of the present disclosure. For example, “one embodiment”, “an embodiment”, and/or “some embodiments” mean a certain feature, structure, or characteristic related to at least one embodiment of the present disclosure. Therefore, it should be emphasized and noted that “an embodiment” or “one embodiment” or “one alternative embodiment” mentioned twice or more in different positions in this description does not necessarily refer to the same embodiment. In addition, some features, structures, or characteristics in one or more embodiments of the present disclosure may be appropriately combined.

In addition, those skilled in the art may understand that various aspects of the present disclosure may be explained and described through a number of patentable categories or situations, including any new and useful working procedure, machine, product, or combination of substances, or any new and useful improvements to them. Correspondingly, various aspects of the present disclosure may be completely executed by hardware, may be completely executed by software (including firmware, resident software, microcodes, etc.), or may be executed by a combination of hardware and software. The above hardware or software may be referred to as a “data block”, “module”, “engine”, “unit”, “component” or “system”. In addition, various aspects of the present disclosure may be embodied as a computer product located in one or more computer-readable media, and the product includes computer-readable program codes.

A computer storage medium may contain a propagated data signal containing computer program codes inside, for example on a baseband or as part of a carrier wave. The propagated signal may have multiple forms of expression, including electromagnetic forms, optical forms, etc., or suitable combined forms. The computer storage medium may be any computer-readable medium other than a computer-readable storage medium, and the medium may be connected to an instruction executing system, device, or equipment to realize a communication, propagation, or transmission program for use. The program code located on the computer storage medium can be transmitted through any suitable medium, including radio, cables, fiber optic cables, RF, or a similar medium, or any combination of the above medium.

The computer program codes required for the operation of each part of the present disclosure can be written with any one or more program languages, including object-oriented programming languages such as Java, Scala, Smalltalk, Eiffel, JADE, Emerald, C++, C#, VB.NET, Python etc., conventionally procedural programming languages such as C language, Visual Basic, Fortran 2003, Perl, COBOL 2002, PHP, and ABAP, dynamic programming languages such as Python, Ruby and Groovy, or other programming languages. The program code can be run entirely on a user's computer, or run as an independent software package on the user's computer, or partly run on the user's computer and partly run on a remote computer, or run entirely on the remote computer or a server. In the latter case, the remote computer can be connected to the user's computer through any network form, such as a Local Area Network (LAN) or a Wide Area Network (WAN), or connected to an external computer (e.g., via the Internet), or in a cloud computing environment, or used as a service such as software as a service (SaaS).

In addition, unless explicitly stated in the claims, the order of processing elements and sequences, the use of numbers and letters, or the use of other names in the present disclosure are not used to limit the order of the processes and methods of the present disclosure. Although the foregoing disclosure uses various examples to discuss some embodiments of the invention that are currently considered useful, it should be understood that such details are only for illustrative purposes, and the appended claims are not limited to the disclosed embodiments. On the contrary, the claims are intended to cover all corrections and equivalent combinations that conform to the essence and scope of the embodiments of the present disclosure. For example, although the system components described above can be realized by hardware devices, they can also be realized only by software solutions, such as installing the described system on an existing server or mobile device.

Similarly, it should be noted that, in order to simplify the expression disclosed in the present disclosure and to help the understanding of one or more embodiments of the invention, in the foregoing description on the embodiments of the present disclosure, multiple features are sometimes combined into one embodiment, drawings or its description. However, this method of disclosure does not mean that the object of the present disclosure requires more features than those mentioned in the claims. In fact, the features of the embodiment are less than all the features of the single embodiment disclosed above.

In some embodiments, numbers describing ingredients and the number of attributes are used. It should be understood that such numbers used for describing the embodiments use the modifiers “about”, “approximately” or “substantially” in some examples for modifications. Unless otherwise stated, “about”, “approximately” or “substantially” indicates that the number is allowed to vary by +/−20%. Correspondingly, in some embodiments, the numerical parameters used in the description and claims are all approximate values, and the approximate values can be changed according to the required characteristics of individual embodiments. In some embodiments, the numerical parameter should consider the prescribed effective digits and adopt the method of general digit retention. Although the numerical ranges and parameters used to confirm the breadth its range in some embodiments of the present disclosure are approximate values, in specific embodiments, the setting of such numerical values is as accurate as possible within the feasible range.

For each patent, patent application, patent application publication and other materials cited in the present disclosure, such as articles, books, descriptions, publications, and documents, its entire contents are hereby incorporated into the present disclosure as a reference. The application history documents that are inconsistent or conflict with the content of the present disclosure are excluded, and documents that restrict the broadest scope of the claims of the present disclosure (currently or later attached to the present disclosure) are also excluded. It should be explained that if there is any inconsistency or conflict between the description, definition, and/or use of terms in the attached materials of the present disclosure and the content of the present disclosure, take the description, definition and/or use of terms in the present disclosure as standards.

Finally, it should be understood that the embodiments described in the present disclosure are only used to illustrate the principles of the embodiments of the present disclosure. Other variations may also fall within the scope of the present disclosure. Therefore, as an example, not a limitation, the alternative configuration of the embodiment of the present disclosure can be regarded as consistent with the teaching of the present disclosure. Accordingly, the embodiments of the present disclosure are not only limited to the embodiments explicitly introduced and described in the present disclosure.

1. A display method for an indicator arrow in a navigation map, the display method comprising:
acquiring at least one indicator arrow information in a navigation route, the at least one indicator arrow information including at least one set of points representing the indicator arrow;
determining a highest point of the indicator arrow on a screen based on the at least one indicator arrow information;
determining a display position of the indicator arrow on the screen after placing the highest point at a preset position of the screen; and
displaying the indicator arrow on the screen.

2. The display method of claim 1, wherein the acquiring the at least one indicator arrow information in the navigation route comprises:
acquiring at least one road transformation information; and
generating the indicator arrow corresponding to the at least one road transformation information based on the at least one road transformation information.

3. The display method of claim 1, wherein the determining the highest point of the indicator arrow on the screen based on the at least one indicator arrow information comprises:
establishing a rectangular coordinate system on the screen, a horizontal axis of the rectangular coordinate system being a horizontal direction of the screen, and a vertical axis of the rectangular coordinate system being a vertical direction of the screen;
determining ordinate values of a set of points of the at least one set of points representing the indicator arrow based on the rectangular coordinate system; and
determining, from the set of points, a point with a greatest ordinate value as the highest point of the indicator arrow.

4. The display method of claim 1, wherein the determining a display position of the indicator arrow on the screen after placing the highest point at a preset position of the screen comprises:
acquiring a display position of a vehicle identification on the screen; and
placing the highest point of the indicator arrow at the preset position on the screen by zooming the navigation map based on the display position of the vehicle identification on the screen, and
determining the display position of the indicator arrow on the screen.

5. The display method of claim 1, wherein the displaying the indicator arrow on the screen comprises:
determining a proportional scale of the navigation map when the highest point is placed at the preset position of the screen; and
determining whether the proportional scale is within a preset range;
in response to determining that the proportional scale is within the preset range, displaying the indicator arrow on the screen; and
in response to determining that the proportional scale is not within the preset range, without displaying the indicator arrow on the screen.

6. The display method of claim 5, wherein the displaying the indicator arrow on the screen further comprises:
acquiring a road width of a road where the indicator arrow is located;
determining a width of the indicator arrow based on the road width and the proportional scale, and
displaying the indicator arrow on the screen according to the width of the indicator arrow.

7. The display method of claim 1, wherein the preset position is a straight line or a region, wherein a distance between the straight line or the region and a position right above the screen is within a first pixel threshold.

8. The display method of claim 2, wherein the indicator arrow includes an indicator arrow corresponding to road transformation information of a next road on the navigation route.

9. The display method of claim 1, wherein the indicator arrow is a 3D indicator arrow, a 2.5D indicator arrow, or a 2D indicator arrow.

10. The display method of claim 1, wherein the indicator arrow includes at least one of: a left turn arrow, a right turn arrow, a go-straight arrow, a turn-round turning arrow, an annular driving arrow, a continuous turning arrow, a left front driving arrow, or a right front driving arrow.

11. A display system for an indicator arrow in a navigation map, wherein the system comprises:
at least one storage medium for storing a set of computer instructions; and
at least one processor in communication with the at least one storage medium, wherein when executing the set of computer instructions, the at least one processor is directed the system to perform operations including:
acquiring at least one indicator arrow information in a navigation route, the at least one indicator arrow information including at least one set of points representing the indicator arrow;
determining a highest point of the indicator arrow on a screen based on the at least one indicator arrow information;
determining a display position of the indicator arrow on the screen after placing the highest point at a preset position of the screen; and
displaying the indicator arrow on the screen.

12. The display system of claim 11, wherein the acquiring the at least one indicator arrow information in the navigation route comprises:
acquiring at least one road transformation information; and
generating the indicator arrow corresponding to the at least one road transformation information based on the at least one road transformation information.

13. The display system of claim 11, wherein the determining the highest point of the indicator arrow on the screen based on the at least one indicator arrow information comprises:
establishing a rectangular coordinate system on the screen, a horizontal axis of the rectangular coordinate system being a horizontal direction of the screen, and a vertical axis of the rectangular coordinate system being a vertical direction of the screen;
determining ordinate values of a set of points of the at least one set of points representing the indicator arrow based on the rectangular coordinate system; and
determining, from the set of points, a point with a greatest ordinate value as the highest point of the indicator arrow.

14. The display system of claim 11, wherein the determining a display position of the indicator arrow on the screen after placing the highest point at a preset position of the screen comprises:
acquiring a display position of a vehicle identification on the screen; and
placing the highest point of the indicator arrow at the preset position on the screen by zooming the navigation map based on the display position of the vehicle identification on the screen, and
determining the display position of the indicator arrow on the screen.

15. The display system of claim 11, wherein the displaying the indicator arrow on the screen comprises:
determining a proportional scale of the navigation map when the highest point is placed at the preset position of the screen; and
determining whether the proportional scale is within a preset range;
in response to determining that the proportional scale is within the preset range, displaying the indicator arrow on the screen; and
in response to determining that the proportional scale is not within the preset range, without displaying the indicator arrow on the screen.

16. The display system of claim 15, wherein the displaying the indicator arrow on the screen further comprises:
acquiring a road width of a road where the indicator arrow is located;
determining a width of the indicator arrow based on the road width and the proportional scale, and
displaying the indicator arrow on the screen according to the width of the indicator arrow.

17. The display system of claim 11, wherein the preset position is a straight line or a region, wherein a distance between the straight line or the region and a position right above the screen is within a first pixel threshold.

18. The display system of claim 12, wherein the indicator arrow includes an indicator arrow corresponding to road transformation information of a next road on the navigation route.

19. The display system of claim 11, wherein the indicator arrow is a 3D indicator arrow, a 2.5D indicator arrow, or a 2D indicator arrow.

20-21. (canceled)

22. A display method for a turning arrow, comprising:
acquiring a turning arrow of at least one intersection, the turning arrow including at least one set of topological points;
determining a highest topological point of the turning arrow;
determining a display position of the turning arrow on the screen after placing the highest topological point of the turning arrow at a preset position on a screen; and
displaying the turning arrow on the screen.

23-25. (canceled)
